(19) United States
(12) Patent Application Publication
(10) Pub. No.: US 2003/0159479 A1
(43) Pub. Date: Aug. 28, 2003

(54) Multi-function locking cam for locks

(76) Inventors: Peter Kajuch, Brookfield, WI (US); Gary R. Burmesch, Port Washington, WI (US)

Correspondence Address: CALFEE HALTER & GRISWOLD, LLP, 800 SUPERIOR AVENUE, SUITE 1400, CLEVELAND, OH, 44114, US

(21) Appl. No.: 10/355,928

(22) Filed: Jan. 31, 2003

Related U.S. Application Data
(60) Provisional application No. 60/354,605, filed on Feb. 5, 2002.

(51) Int. Cl. E05B 9/10; E05B 17/04

(52) U.S. Cl. 70/379 R; 70/38 A

(57) ABSTRACT

A locking device for locking systems that use different key cylinder types. The locking device is capable of allowing a key to be removed when a lock is in an unlocked position or retaining the key within the padlock body in an unlocked position. The device prevents fatigue of an internal torsion spring and creates more stability for all the internal mechanisms inside the padlock body.

### CROSS-REFERENCE TO RELATED APPLICATIONS

This invention claims priority to U.S. Provisional Patent Application Serial No. 60/354,605, filed Feb. 5, 2002.

### BACKGROUND

The prior art locking cam, as shown in FIG. 7 of the drawings, includes a locking cam (20), a torsion spring (27), and a ring plate (28). The locking cam has crescent shaped cutouts (30) for mating engagement with a set of ball bearings, a spring retention slot (29), bearing surfaces (26) with a reduced diameter section (22), and driver surface (31). When assembled, a first end (32) of the torsion spring (27) is retained in the slot (29), the locating ring (28) is placed on the reduced diameter section (22) of the cam, and the second end (33) of the torsion spring (27) is wound to allow attachment to a projection (34) on the locator ring (28). When the locking cam (20) is inserted into a cavity in a lock body, the projection (34) on the locator ring (28) positions the locking cam (20) into the correct orientation in the lock body cavity by insertion into a retention cavity. A key cylinder then contacts the locking cam at the driver surface (31) such that when the key cylinder is rotated from locked to unlocked positions, the locking cam is rotated such as to align the cutouts (30) with the ball bearings. When the cutouts (30) and ball bearings are aligned, the ball bearings can move into the cutouts (30) thereby allowing the toe side of the_shackle to be removed from the lock body.

In the prior art structure, the torsion spring is located on the outside of the cam and the ring plate is used to orient one end of the spring in the lock. In use, the prior art locking assembly has a tendency to tip off-axis since the outer diameter of the assembly is not constant and therefore does not match to the constant diameter bore in the lock body. In addition, as the cam of the lock rotates the spring will cock. The rotation of the spring causes the spring coil to elongate. The torsional force and elongation cause the spring to get off axis creating instability in the assembly.

### SUMMARY OF THE INVENTION

One embodiment of the invention is a locking device for padlocks with multi-functioning cams. The locking device contains a cam and a driver partially housed within the cam. The locking device also contains a torsion spring housed within the driver.

A method of locking and unlocking the locking device by rotating a key cylinder in a clockwise direction in which an assembled driver, spring, and cam are connected to the key cylinder. The key cylinder causes the driver to rotate in a clockwise direction, in which the direction of rotation is defined by viewing towards the key insertion point of the key cylinder. The driver drives the cam by applying a torque to a drive surface of the cam. The torque rotates the cam in a clockwise direction. A spring end stops the rotation of the cam by butting against a stop surface of the cam.

An option desired by customers is to be able to insert and have operate a variety of key cylinders and the invention accommodates this desire by implementing three different styles of drivers that can be used in the assembly. The type of cylinder used in a lock is also dependent upon the geometry of the lock body. The customers also have a requirement for two different modes of operation commonly known as Non Key Retaining (NKR) and Non Removable Key (NRK). In order to provide the NKR function, the invention must be capable of allowing the driver component to turn independently without affecting the orientation of the cam component. This motion without interaction is commonly called ‘lost motion.’

### BRIEF DESCRIPTION OF THE DRAWINGS

FIG. 1 shows a perspective view of one embodiment of the internal components of the locking device assembled.

FIGS. 2A, 2B, and 2C show perspective views of different embodiments of a driver of the present invention.

FIGS. 3A and 3B show a perspective view of different embodiments of a spring of the present invention.

FIGS. 4A and 4B show perspective views of different embodiments of a cam of the present invention.

FIG. 5 shows a perspective view of one embodiment of a cam of the present invention.

FIG. 6 shows an exploded view of one embodiment of the present invention.

FIG. 7 shows an exploded view of the prior art.

### DETAILED DESCRIPTION OF THE INVENTION

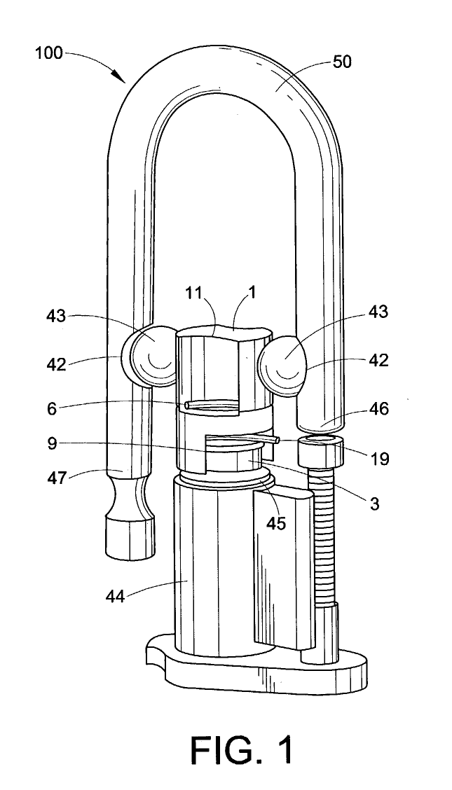

The invention will be described in reference to the drawings. FIG. 1 shows the internal mechanisms of a padlock body 100 a driver 3, a torsion spring 6, and a cam 1. The driver 3 is housed partially in the cam 1. Located within the driver 3 and in contact with the cam 1 is the torsion spring 6.

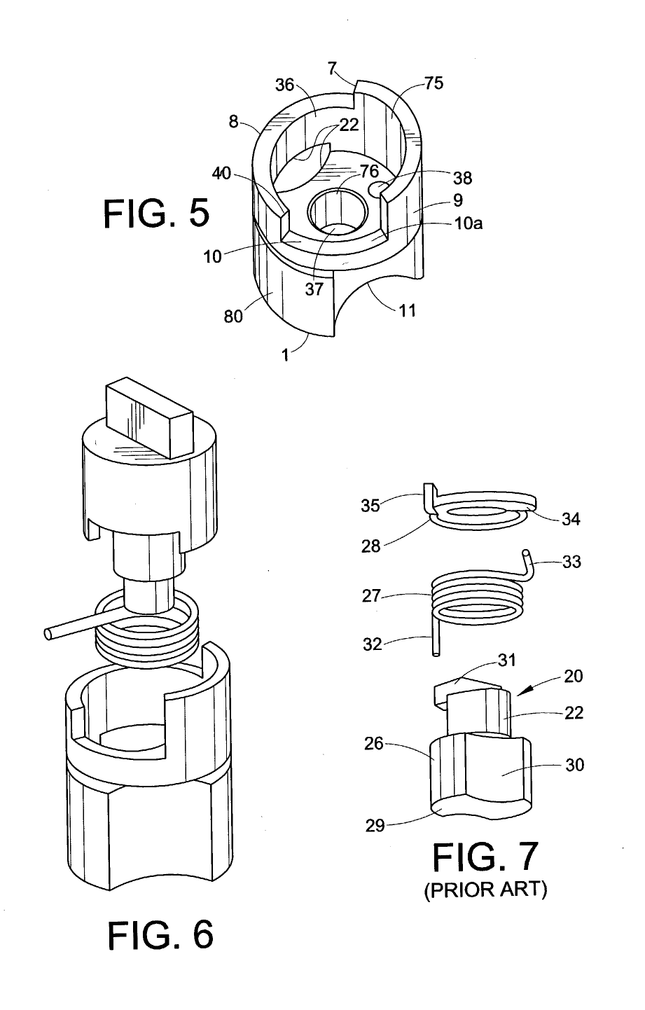

As shown in FIG. 5, the cam 1 is generally cylindrical with two crescent shaped recesses 11 cut from an external wall 80 of the cam 1. In addition, the cam 1 has a cavity 36 formed by the internal wall of the cam and extending approximately half-way down cam 1. The external wall of cam 1 extends to a variety of heights, thereby forming two stop surfaces 7 and 9. Two ledges 8 and 10 connect the two stop surfaces 7 and 9 and are at two different heights. Ledges 8 and 10 meet at rest surface 40. Thus, aperture 10a is formed by stop surface 9, rest surface 40 and ledge 10.

The crescent shaped recesses 11 and the first cavity 36 of the cam 1 intersect and form two windows 22. In addition to the first cavity 36, there is a second cavity 37 within the first cavity 36 that extends deeper inside the cam 1. Bearing surfaces 75 and 76 are formed by the internal walls inside the two cavities 36 and 37.

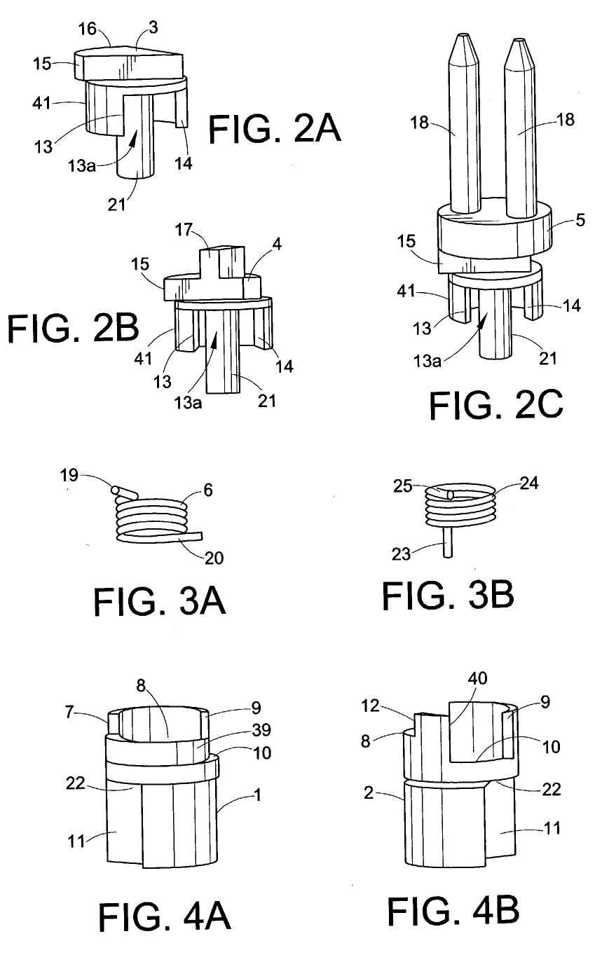

The driver may be a number of different embodiments, as shown in FIGS. 2A, 2B, and 2C, each having a pivot rod 21, a trepanned collar 41 with an aperture 13a formed by wall surfaces 13 and 14, and two drive surfaces 15 and 16.

Shown in FIG. 3A, the torsion spring 6 is a coiled spring with two radially protruding ends identified as a long end 19 and a short end 20.

When assembled, the torsion spring 6 fits inside the trepanned collar 41 of the driver 3 so that the long spring end 19 projects through the aperture 13a of the driver and the short spring end 20 extends beyond the trepanned collar 41 and engages cam 1 or 2 at one of the two windows 22, but does not extend beyond the external wall 80 of cam 1 or 2. The aperture 13a prevents relative motion between the long spring end 19 and the locking mechanisms in at least one direction. The driver pivot rod 21 fits in the second cavity 37 of the cam 1 and the short spring end 20 is engaged through the window 22 of the cam 1 directly under the additional ledge 10. The driver rests on and is supported by ledge 8. The bearing surfaces 75 and 76 within the first and second cavities 36 and 37 stabilize the driver 3 within the cam 1 to eliminate tilt. During assembly, a preload is applied to the torsion spring 6 via the driver 3 to cause the long spring end 19 to project through the cam aperture 10a.

The driver is engaged with the end of a key cylinder 44 called a cylinder plug 45. Three different embodiments of the driver 3, 4 and 5 are shown in FIGS. 2A, 2B, and 2C illustrating a different engaging structure with the key cylinder 44. FIG. 2A shows a first embodiment for the driver 3 which is designed to engage a tenon on the end of a key cylinder with the drive surface 15 on the end of the driver 3. FIG. 2B shows a second embodiment for the driver 4 which is designed to engage the cylinder plug 45 of various door hardware type key cylinders via a tenon 17. FIG. 2C shows a third embodiment for the driver 5 which is designed to engage a small format interchangeable core via throw member studs 18.

The key cylinder 44 applies clockwise torque to the drive surface 15 of the driver 3, the tenon 17 of the driver 4, or the throw member studs 18 of the driver 5, depending upon which driver is used in the assembly. The torque is transferred to drive surface 16 of the driver which in turn transfers the torque to stop surface 7 of the cam 1 or 2. The long spring end 19 has been at rest against rest surface 39 or 40 of the cam 1 or 2 and held captive within a cavity in cam 1 or 2. Cam 1 or 2 turns clockwise as a result of the torque and can continue to rotate until the stop surface 9 of cam 1 or 2 makes contact with the long spring end 19 and the rotation of cam 1 or 2 is stopped. At some point in the rotation, the recesses 11 in cam 1 or 2 become aligned to allow the ball bearings 43 to move toward the center of cam 1 or 2 to a point where the ball bearings 43 no longer engage the crescent shaped cutouts 42 in the shackle 50. Shackle 50 may be pulled outward from the padlock body 100 until the toe end 46 is clear and in the unlocked position while the heel end 47 of shackle 50 is retained in the padlock body 100.

When shackle 50 is in the unlocked position the heel end ball bearing 43 is trapped between shackle 50 and cam 1 or 2 to prevent withdrawal of the heel end 47 from the padlock body 100. Cam 1 or 2 is under spring pressure from the winding of the torsion spring 6. After the toe end 46 of shackle 50 is returned to the closed position this spring pressure rotates the cam counter-clockwise and the cam pushes outward on the ball bearings 43 and forces the ball bearings 43 out of recesses 11 in the cam into the crescent shaped cutouts 42 in shackle 50 locking the padlock body 100.

In operation of the NKR (Non Key Retaining) version of the invention shown in FIGS. 4A and 5, stop surface 12 is eliminated thereby allowing counter-clockwise rotation of the driver 4 even though the cam 1 is held in position via the relationship of the ball bearings 43 and the unlocked shackle 50. Torque may be applied to the key in the counter-clockwise direction to allow the key cylinder to be rotated to the key pull position, thus allowing withdrawal of the key from the key cylinder 44. The torsion spring 6 is now under full load and applying torque to the cam 1 in a counter-clockwise direction. When the shackle 50 is pushed back into the locked position within the padlock body 100 the torque on the cam 1 forces the ball bearings 43 away from the center of the cam 1 and out of the recesses 11 and into the crescent shaped cutouts 42 in the shackle 50, locking the shackle 50 into place. When the ball bearings 43 are no longer engaging the recesses 11, the cam 1 is rotated in a counter-clockwise direction until surface 39 makes contact with the long spring end 19.

In operation of the NRK (Non Removable Key) version of the invention shown in FIG. 4B, the added surface 12 on the NRK cam 2 is in direct contact with surface 15 of the driver 5 and the driver 5 cannot turn in a counter-clockwise direction unless the cam 2 does. The torsion spring 6 is now under full load and applying torque to the cam 2 in a counter-clockwise direction. When the shackle 50 is pushed back into the locked position within the padlock body 100 the torque on the cam 2 forces the ball bearings 43 away from the center of the cam 2 and out of the recesses 11 and into the crescent shaped cutouts 42 in the shackle 50, locking the shackle 50 in place. When the ball bearings 43 are no longer engaging the recesses 11, the cam 2 is rotated in a counter-clockwise direction until surface 40 makes contact with the long spring end 19.

FIG. 3B illustrates the same component relationships using a different torsion spring 24. The spring end 25 corresponds to the short spring end 20 on torsion spring 6 for location and function and a longitudinal spring end 23 is designed to enter a third cavity 38 in the cam. This third cavity 38 prevents rotation of the longitudinal spring end 23 relative to the cam. With longitudinal spring end 23 in a third cavity 38, shown in FIG. 5, and spring end 25 against driver surface 13, the driver is rotated until surface 16 of the driver rests against surface 7 of the cam. In this orientation spring end 25 continues to rest against surface 13 of the driver which is coplanar with surface 39 of the cam. This rotation of the driver provides the preload needed for correct operation of the invention.

Although the present invention has been described in detail with reference to certain preferred embodiments thereof, other embodiments are possible. Therefore, the spirit and scope of the appended claims should not be limited to the description of the preferred embodiment contained herein.

What is claimed is:

1. A locking device comprising:
a cam;
a driver which is partially housed within said cam; and
a torsion spring housed within said driver.

2. The locking device of claim 1 wherein said driver comprises:
a fastening means for fastening said driver to said cam at one end of said driver;
a housing for a spring formed by an external wall of said driver;
a driving end of said driver not housed inside said cam; and
two vertical drive surfaces (15,16) on said driving end.

3. The locking device of claim 2 wherein said fastening means is a pivot rod.

4. The locking device of claim 2 wherein said housing is a trepanned collar, wherein said collar has two vertical ends (13,14), wherein an opening (13a) is formed by said two vertical ends of said collar, wherein the end of said driver comprises an attaching means for attachment to a key cylinder.

5. The locking device of claim 4 wherein said attaching means is a tenon.

6. The locking device of claim 4 wherein said attaching means is at least one throw member stud.

7. The locking device of claim 4 wherein said housing of said driver houses said torsion spring, wherein said torsion spring is coiled around said fastening means of said driver.

8. The locking device of claim 7 wherein said cam comprises:
a first cavity at one end of said cam surrounded by a first bearing surface which forms an inner wall of said cam;
a second cavity within said first cavity surrounded by a second bearing surface which forms an additional inner wall of said cam; and
two recesses cut into opposite sides of an external wall of said cam;
wherein said first cavity and said recesses intersect to form two windows;
wherein a first aperture (10a) is formed in said external wall of said cam by a vertical first stop surface (9), a vertical rest surface (39), and a first ledge (10).

9. The locking device of claim 8 wherein said first stop surface is greater in height than said rest surface.

10. The locking device of claim 8 wherein said first stop surface is the same height as said rest surface.

11. The locking device of claim 8 wherein said cam comprises a second ledge (8).

12. The locking device of claim 11 wherein said second ledge abuts a second stop surface (7) at one end.

13. The locking device of claim 11 wherein said second ledge abuts a second stop surface (7) at one end and a third stop surface (12) at the other end.

14. The locking device of claim 13 wherein said torsion spring comprises a short end and a long end.

15. The locking device of claim 14 wherein said short end of said torsion spring is in a horizontal position.

16. The locking device of claim 14 wherein said short end of said torsion spring is in a vertical position.

17. The locking device of claim 14 wherein said piston rod of said driver fits in said second cavity of said cam, wherein said driver rests on said second ledge of said cam and wherein said one horizontal driving surface (16) of said driver abuts against said second stop surface (7) of said cam.

18. The locking device of claim 14 wherein said long end of said torsion spring fits through an opening in said housing of said driver and said first aperture of said cam, wherein said opening is created by two vertical ends of said housing, wherein said end of said driver engages an end of a key cylinder, and wherein said end of said key cylinder is a cylinder plug.

19. The locking device of claim 15 wherein said short end of said torsion spring goes through one said window of said cam.

20. The locking device of claim 16 wherein said short end of said torsion spring fits in a third cavity of said cam located in said first cavity and adjacent to said second cavity.

21. A method of locking and unlocking comprising the steps of:
rotating said key cylinder in a clockwise direction wherein an assembled driver, spring, and cam are connected to said key cylinder;
rotating said driver in a clockwise direction driving said cam with a drive surface of said driver;
applying torque to a stop surface of said cam;
rotating said cam in a clockwise direction; and
stopping said cam from further rotation with a spring end butting against a stop surface of said cam.

22. The method according to claim 21 comprising:
rotating said driver in a counter-clockwise direction after stopping said cam.

23. The method according to claim 21 comprising:
preventing the rotation of said driver in a counter-clockwise direction after stopping said cam.

24. The method according to claim 23 wherein preventing the counter-clockwise rotation of said driver is caused by an additional stop surface of said cam engaging a driver surface of said driver.
